(19) United States
(12) Patent Application Publication
(10) Pub. No.: US 2007/0135608 A1
(43) Pub. Date: Jun. 14, 2007

(54) Process for the preparation of polyisocyanates containing carbodiimide and/or uretonimine groups

(75) Inventors: Frithjof Hannig, Dusseldorf (DE); Manfred Schmidt, Dormagen (DE); Hartmut Nefzger, Pulheim (DE); Wolfgang Friederichs, Koln (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/634,545

(22) Filed: Dec. 6, 2006

(30) Foreign Application Priority Data
Dec. 9, 2005 (DE) 102005058835.2

(51) Int. Cl. C08G 18/16

(52) U.S. Cl. 528/48

(57) ABSTRACT

The present invention relates to a process for the preparation of carbodiimide- and/or uretonimine-modified polyisocyanates by means of microwave radiation and to the use of such polyisocyanates for the synthesis of foamed and non-foamed polyurethane materials.

### CROSS-REFERENCE TO RELATED APPLICATIONS

The present application claims the right of priority under 35 U.S.C. §119 (a)-(d) of German Patent Application No. 10 2005 058 835.2, filed Dec. 19, 2005.

### BACKGROUND OF THE INVENTION

The present invention relates to a process for the preparation of polyisocyanates containing carbodiimide (CD) and/or uretonimine (UI) groups by means of synthesis assisted by microwave radiation, and the use thereof.

Polyisocyanates are valuable and essential raw materials for polyurethane chemistry and are employed on a large industrial scale as hard segment units in the production of foamed and non-foamed polyurethane (PU) materials.

For optimization of PU material properties, a large number of modifications, some involving the polyisocyanates, have been carried out, and implemented industrially. However, it is also desirable to optimize the properties of the polyisocyanates themselves. For example, 4,4′-diphenylmethane-diisocyanate (4,4′-MDI) has a melting point of about 42° C., which means an increased expenditure on processing compared with other polyisocyanates which are in liquid form at room temperature. One of the possibilities of eliminating this disadvantage is partial conversion of the NCO groups of 4,4′-MDI into carbodiimide groups, as is outlined in the following equation:

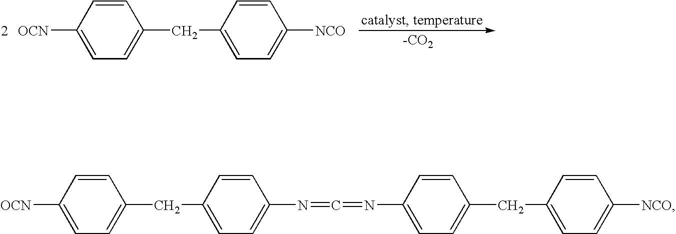

The carbodiimide groups can react further with excess isocyanate groups to give uretonimines.

Polyisocyanates modified in this way are also called “partially carbodiimidized” polyisocyanates, in order to illustrate that only partial conversion of NCO groups into carbodiimide/uretonimine groups is achieved. Such a reaction to give carbodiimide depends critically on the reaction conditions, and in particular, on the nature and amount of catalyst used.

1 -Methylphospholine oxide has proved suitable as the catalyst, although it is possible to use aromatic polyisocyanates and inert solvents to obtain high molecular weight polycarbodiimides which can also be processed by thermoforming, at least if monofunctional isocyanates are co-used as chain terminators (H. Ulrich, Chemistry and Technology of Isocyanates, John Wiley and Sons, 1996, p. 411). Carbodiimides from monofunctional isocyanates are furthermore used in combination with antioxidants as stabilizers in polyesters, polyester-based polyurethanes and in polyether-based poly(urethane-ureas).

Aliphatic polyisocyanates can likewise be reacted by means of phospholine oxide. During the reaction, at temperatures of 20-50° C., hexamethylene-diisocyanate (HDI) does not split off the carbon dioxide formed, but incorporates it directly in the isomeric form (H. Ulrich, Chemistry and Technology of Isocyanates, John Wiley and Sons, 1996, p. 411).

Polyisocyanate mixtures containing CD/UI groups can be prepared with highly active catalysts from the phospholine series, in particular the phospholine oxide series, by the processes according to U.S. Pat. No. 2,853,473 and EP-A 515 933 or U.S. Pat. No. 6,120,699. Such polyisocyanate mixtures containing CD/UI groups which have been prepared from aromatic polyisocyanates have comparatively low degrees of modification compared to the abovementioned polycarbodiimides. Further catalysts which can be used are described in U.S. Pat. No. 6,120,699, EP-A 0989116 and EP-A 0193787.

If phospholine catalysts, in particular phospholine oxide catalysts, are employed, due to their high catalytic activity these catalysts must be stopped when the reaction has ended.

Suitable stoppers are described, e.g., in EP-A 515 933, EP-A 609 698 and U.S. Pat. No. 6,120,699 and include acids, acid chlorides, chloroformates and silylated acids, such as, e.g., trimethylsilyltrifluoromethanesulfonic acid esters, or alkylating agents, such as trifluoromethanesulfonic acid alkyl esters.

The esters of phosphoric acid (e.g. triethyl phosphate) according to EP-A 0193787 represent another group of suitable catalysts. Those catalysts are distinguished in that polyisocyanate mixtures containing CD/UI groups which have been prepared with them do not have to be stopped. Nevertheless, the reactions must be carried out at elevated temperatures, e.g., more than 200° C., and the reaction products are undesirably dark in color due to the high exposure to heat. It is also necessary to quench the reaction product to temperatures below 100° C. very rapidly after the reaction has been carried out, in order to limit the undesirable side reaction that produces the dimer.

The group of highly active phospholine and phospholine oxide catalysts does not have that disadvantage, because reactions catalysed with these can be carried out at temperatures of from about 60to 100° C., so that the undesirable dimerization can be avoided. Nevertheless, conventional reaction times of reactions catalysed in this manner are about 8 to 10 hours, so that an acceleration of the reaction is desirable from the economic aspect.

An increase in the reaction temperature to e.g. 120 to 150° C. to accelerate the reaction is not possible, because this not only accelerates the desired modification to isocyanates containing carbodiimide and/or uretonimine groups, but the formation of isocyanate dimers also takes place. A disadvantage is that the dimers are sparingly soluble and lead to undesirable clouding.

The object of the present invention is to increase the space/time yield in the preparation of polyisocyanates containing carbodiimide (CD) and/or uretonimine (UI) groups at the lowest possible reaction temperature, and at the same time to avoid the formation of undesirable by-products and to obtain clear products without clouding.

Furthermore, the amount of catalyst should be reduced, so that the amount of stopper can be minimized.

### SUMMARY OF THE INVENTION

Surprisingly, it has been found that the abovementioned objects can advantageously be achieved by carrying out the carbodiimide/uretonimine modification with the aid of microwave radiation.

The present invention provides a method of preparing polyisocyanates containing carbodiimide and/or uretonimine groups, comprising:
a) mixing polyisocyanates with a catalyst; and
b) irradiating the mixture with microwave radiation,
   wherein the NCO value of the polyisocyanates prior to the irradiation step is greater than the NCO value of the polyisocyanates after the irradiation step.

### DETAILED DESCRIPTION OF THE PREFERRED EMBODIMENTS

Microwave radiation is understood as meaning radiation in the frequency range from 300 MHz to 300 GHz, or the wavelength range from 1 m to 1 mm (Römpp, Chemie Lexikon, Thieme Verlag, 9th ext. and revised ed., 1995, p. 2785).

The literature merely describes syntheses for the preparation of low molecular weight compounds by means of microwave radiation in solvents on the laboratory scale (B. L. Hayes, Microwave Synthesis, Chemistry at the Speed of Light, CEM Publishing, Matthews, N.C. 28105, p. 77-156). Syntheses in solvents are undesirable in industrial installations.

Surprisingly, it has been found that microwaves significantly accelerate the carbodiimidization of polyisocyanates, and produce clear reaction products.

In a typical experimental set-up, for example, the commercially obtainable mono-mode microwave apparatus “Discover™” from CEM, Kamp-Lintfort, Germany can be employed (frequency 2.45 GHz). A 100 ml reaction vessel was used in the experiments described in more detail in the following. The apparatus from CEM is distinguished, inter alia, in that it can generate a comparatively high energy density for microwave apparatuses, which moreover can be maintained for a relatively long time by the possibility of simultaneous cooling. The exposure of the reaction mixture to heat can likewise be kept very low.

Energy densities of more than 200 watt/litre are preferred. The irradiation with microwave energy with simultaneous cooling of the reaction mixture is also included. Thus, in spite of a high energy input, only a comparatively low reaction temperature is reached. Compressed air is preferably used for the cooling; however, other cooling systems can also be used, in particular those with a liquid cooling medium.

The use of microwave apparatuses is of course not limited to mono-mode apparatuses, but multi-mode apparatuses can also be used. Multi-mode apparatuses are comparable to the generally known domestic appliances and have inhomogeneous microwave fields, i.e. because of this irregular microwave distribution so-called hot and cold spots occur within the microwave chamber, which can be largely compensated by rotation of a microwave plate.

In contrast, mono-mode apparatuses have a homogeneous microwave field and a specific chamber design that eliminate such hot and cold spots.

The process according to the invention can be carried out not only batchwise, but, by using a pump and suitable tube reactors, also continuously. It is also possible to connect several microwave apparatuses in series or in parallel.

The process can of course also be carried out under increased or reduced pressure. The latter may be preferred, because aromatic polyisocyanates produce carbon dioxide as a reaction product that must be removed from the reaction space. The removal of the carbon dioxide can of course also be carried out in a second reaction step after the reaction has ended per se. Combinations of a type such that one portion of the carbon dioxide still in the microwave field and the other portion is separated off by after-treatment of the reaction product which is finished per se are also possible.

Carrying out the process under increased pressure can be considered, for example, if due to technical circumstances there is no possibility of sluicing out the carbon dioxide in the microwave field. In such a case, the carbon dioxide bubbles produced (e.g., in tube reactors) will reduce the flow rate of polyisocyanate at a constant irradiation time of a given reaction volume.

The process is preferably carried out without the use of a solvent. However, in specific cases, e.g., in the case of polyisocyanates of increased viscosity, a solvent can optionally be utilized.

Preferred polyisocyanates are organic di- or polyisocyanates or polyisocyanate prepolymers. Possible di- or polyisocyanates are aliphatic, cycloaliphatic, araliphatic, aromatic and heterocyclic polyisocyanates, such as are described in Justus Liebigs Annalen der Chemie 562, (1949) 75, for example those of the formula:
Q(NCO)ₙ
in which
n denotes an integer from 2 to 4, preferably 2, and
Q denotes an aliphatic hydrocarbon radical having 2 to 18, preferably 6 to 10 C atoms, a cycloaliphatic hydrocarbon radical having 4 to 15, preferably 5 to 10 C atoms, an aromatic hydrocarbon radical having 6 to 15, preferably 6 to 13 C atoms, or an araliphatic hydrocarbon radical having 7 to 15, preferably to 13 C atoms.

Polyisocyanates such as those described in DE-A 28 32 253 are preferred. The polyisocyanates which are readily accessible industrially are particularly preferably employed. Examples include 2,4- and 2,6-toluylene-diisocyanate and any desired mixtures of the isomers (“TDI”), polyphenylene-polymethylene-polyisocyanates, such as those prepared by aniline-formaldehyde condensation and subsequent phosgenation (“crude MDI”), and monomeric diisocyanates separated off therefrom, such as 4,4′- and/or 2,4′- and/or 2,2′-diphenylmethane-diisocyanate and mixtures thereof.

The polyisocyanates containing carbodiimide (CD) and/or uretonimine (UI) groups which are prepared by the process according to the invention by means of synthesis assisted by microwave radiation can be used in the manner known to the person skilled in the art. For example, they may be blended with non-modified polyisocyanates or reacted with polyols to prepare NCO prepolymers or OH prepolymers. The products obtained by the process according to the invention can furthermore be employed for the preparation of all types of PU materials.

The invention is to be explained in more detail with the aid of the following examples.

### EXAMPLE

### Comparison Example

1,000 g 4,4′-MDI (Desmodur 44M® from Bayer MaterialScience AG, Leverkusen, Del.) were initially introduced into the reaction vessel at 60° C. under N₂, and 2.5 mg (=2.5 ppm) 1-methyl-phospholine oxide were added. The mixture was heated to 90° C. and stirred at this temperature for approx. 8 h, until 8.7 liters CO₂ had been split off. Twice the molar amount of trifluoromethanesulfonic acid trimethylsilyl ester (TMST) was then added to the reaction mixture and the mixture was cooled.

A clear product was obtained. The NCO content was 29.5 wt. %; the viscosity was 35 mPas (25° C.).

### Example 1 (according to the invention)

Preparation of polyisocyanates containing carbodiimide (CD) and/or uretonimine (UI) groups by means of synthesis assisted by microwave radiation with phospholine oxide catalysis.

1,294.8 g 4,4′-MDI (Desmodur 44M® from Bayer MaterialScience AG, Leverkusen, Del.) and various amounts (as listed in Table 1, e.g., 3.25 mg (2.5 ppm)) of phospholine oxide were mixed, while stirring. For carrying out the irradiation (see Table 1), in each case 80 g of the mixture were transferred into a 100 ml glass flask and then exposed to microwave radiation in a mono-mode microwave apparatus from CEM (Discover), the following reaction parameters being varied:

Reaction time: 5-60 minutes; constant microwave energy input of from 200 to 300 W under continuous cooling with compressed air.

The course of the reaction was monitored via the amount of CO₂ formed with the aid of a gas meter. The reactions were in each case stopped by addition of 5 ppm TMST when in each case 705 ml CO₂ had been split off. Clear reaction products were obtained. The NCO content and the viscosity were determined.

TABLE 1
Reaction conditions and results

| | | | | NCO content after | | |
|---|---|---|---|---|---|---|
| | Phospholine | Energy | Reaction | discontinuation of | Viscosity at | |
| | oxide amount | input | time | the reaction | 25° C. | |
| Experiment | [ppm] | [W] | [min] | [wt. %] | [mPas] | Appearance |
| 1-1 | 2.5 | 300 | 5 | 29.6 | 36 | clear |
| 1-2 | 2.0 | 300 | 5 | 30.1 | 30 | clear |
| 1-3 | 1.2 | 300 | 15 | 29.7 | 31 | clear |
| 1-4 | 0.9 | 200 | 60 | 28.9 | 43 | clear |

The examples in Table 1 clearly show that it is possible for the reaction for the preparation of clear polyisocyanates containing carbodiimide (CD) and/or uretonimine (UI) groups by the process according to the invention to be carried out in a considerably shorter time, so that the space/time yield is clearly higher than in the comparison experiment.

### Example 2 (according to the invention)

Preparation of polyisocyanates containing carbodiimide (CD) and/or uretonimine (UI) groups by means of synthesis assisted by microwave radiation with triethyl phosphate catalysis

81.2 g 4,4′-MDI were stirred with 1.65 g (2 wt. %, Experiment 2-1, Table 2) or 0.82 g (1 wt. %, Experiment 2-2, Table 2) triethyl phosphate (TEP) in a 100 ml glass flask. These mixtures were then exposed to microwave radiation in a mono-mode microwave apparatus from CEM (Discover), the reaction conditions listed in Table 2 being maintained. The microwave energy input of 300 W was constant; no cooling was carried out. The course of the reactions was monitored via the amount of CO₂ formed with the aid of a gas meter. The reactions were discontinued when 710 ml CO₂ had been split off. The reactions were stopped by lowering the temperature. The NCO content, the viscosity and the appearance of the reaction products were determined (Table 2).

TABLE 2
Reaction conditions and results

| | | | | NCO content after | | |
|---|---|---|---|---|---|---|
| | Triethyl | Energy | Reaction | discontinuation | Viscosity at | |
| | phosphate | Input | time | of the reaction | 25° C. | |
| Experiment | [wt. %] | [W] | [min:sec] | [wt. %] | [mPas] | Appearance |
| 2-1 | 2.0 | 300 | 5:45 | 29.3 | 37 | clear |
| 2-2 | 1.0 | 300 | 5:48 | 29.4 | 36 | clear |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A method of preparing polyisocyanates containing carbodiimide and/or uretonimine groups, comprising:
a) mixing polyisocyanates with a catalyst; and
b) irradiating the mixture with microwave radiation,
wherein the NCO value of the polyisocyanates prior to the irradiation step is greater than the NCO value of the polyisocyanates after the irradiation step.

2. A method according to claim 1, wherein the mixture is irradiated using monomodal microwave radiation with homogeneous microwave radiation fields.

3. A method according to claim 1, wherein the mixture is irradiated using multimodal microwave radiation with heterogeneous microwave radiation fields.

4. A method according to claim 1, wherein the polyisocyanates are selected from the group consisting of diphenylmethane-diisocyanates, polyphenylene-polymethylene-polyisocyanates and toluylene-diisocyanates.

5. A method according to claim 4, wherein the polyisocyanates are selected from the group consisting of 4,4′-, 2,4′-, 2,2′-MDI and mixtures thereof.

6. A method according to claim 4, wherein the polyisocyanates are selected from the group consisting of 2,4-, 2,6-TDI and mixtures thereof.

7. A method according to claim 1, wherein the polyisocyanates containing carbodiimide and/or uretonimine groups have NCO values of from 20 to 46 wt. %.

8. A method according to claim 1, wherein the catalyst is selected from the group consisting of phospholine catalysts, phospholine oxide catalysts and esters of phosphoric acid.

9. Isocyanate blends containing the modified polyisocyanates prepared by the method of claim 1.

10. Isocyanate prepolymers prepared utilizing the modified polyisocyanates prepared by the method of claim 1.

11. Polyurethane materials prepared utilizing the modified polyisocyanates prepared by the method of claim 1.
